(19) United States
(12) Patent Application Publication
(10) Pub. No.: US 2018/0025064 A1
(43) Pub. Date: Jan. 25, 2018

(54) SYSTEM AND METHOD FOR SYNCHRONIZING IDENTIFIERS ASSOCIATED WITH USERS

(71) Applicant: Adbrain Ltd, London (GB)

(72) Inventors: Jason Atlas, London (GB); Kalo Fady, London (GB); Ashley Timothy Abraham, London (GB)

(21) Appl. No.: 15/214,762

(22) Filed: Jul. 20, 2016

(51) Int. Cl. G06F 17/30; G06F 7/02

(52) U.S. Cl. CPC G06F 17/30557; G06F 7/02; G06F 2216/03

(57) ABSTRACT

Disclosed is a method for synchronizing identifiers associated with a plurality of users. The method comprises receiving the data associated with a plurality of users, and thereafter integrating the data associated with the plurality of users and a pre-stored data of the identity management system in such a way to maximize the scale and quality of overall data. The plurality of users has respective computing devices and the computing devices are communicably coupled to the identity management system in operation through a data communication network. The method further comprises comparing the data associated with the plurality of users and the pre-stored data of the identity management system to generate at least one graph indicating at least one pattern between the data associated with the plurality of users and the pre-stored data of the identity management system.

### TECHNICAL FIELD

The present disclosure relates to a method and a system for synchronizing identifiers associated with the users, namely for associating users' data with pre-stored data in general.

### BACKGROUND

In past few years, there has been a surge in usage of data communications networks by users for performing different activities, such as social networking, executing e-commerce transactions, communicating data, providing and/or receiving entertainment, and so forth. The data communications networks include, for example, the Internet (operating pursuant to TCP/IP), for performing various user activities. Nowadays, many data mining companies analyze and utilize data pertaining to activities of users coupled to the Internet in order to extract substantial information relating to personalities of the users, spatial locations of the users, shopping preferences of the users, personal interests of the users, trends associated with the users, and so forth. Such analyzed data, namely information, assists the data mining companies to plan customer-centric marketing strategies, such as targeted advertising campaigns, targeting a specific demographic area, targeting a group of users, and provide to its customers or users, some improvements in data delivery performance, improvements in technical data processing and so forth.

Nowadays, an ability to perform such tasks by the data mining companies and present to the users or organizations, a proprietary graph showing the analyzed data is a nascent field. A proprietary graph is an algorithm that is operable to execute steps needed for performing such tasks. Presently, there exist many techniques for generating and/or using the proprietary graphs. These techniques rely on accumulating data from the users (or the customers), and further merging the data with a data set having data feeds collected from multiple sources. A few other techniques use only data collected from the users for performing aforementioned tasks. However, most of these techniques do not show to the users or the organizations how their data stands as a whole in relation to the aforesaid marketplace.

Therefore, in light of the foregoing drawbacks associated with known conventional systems and methods, there exists a need to address, for example to overcome, the aforementioned drawbacks of conventional techniques associated with generation and/or usage of proprietary graphs.

### SUMMARY

The present disclosure seeks to provide a method of synchronizing identifiers associated with a plurality of users.

Moreover, the present disclosure further seeks to provide a system for synchronizing identifiers associated with a plurality of users.

In an aspect, an embodiment of the present disclosure provides a method comprising:
receiving data associated with a plurality of users, wherein the plurality of users have respective computing devices, and wherein the computing devices are communicably coupled in operation to an identity management system through a data communication network;
integrating the data associated with the plurality of users and a pre-stored data of the identity management system; and
comparing the data associated with the plurality of users and the pre-stored data of the identity management system to generate at least one graph indicating at least one pattern between the data associated with the plurality of users and the pre-stored data of the identity management system.

Optionally, the method includes generating the at least one pattern to correspond to a device pattern found within the data associated with the plurality of users and the pre-stored data of the identity management system.

Optionally, the method further comprises determining a device footprint within the data associated with the plurality of users using the device pattern.

[0010]Optionally, the method further includes storing the data associated with the plurality of users versus the pre-stored data associated with the identity management system in a partitioned fashion.

Optionally, the data associated with the plurality of users comprises at least one of: a plurality of postbacks, a plurality of pixels, a plurality of logs, cookie information, a plurality of signals, information associated with a plurality of sensors and information associated with a plurality of bots.

Optionally, the method further includes executing a pairing algorithm when comparing the data associated with the plurality of users and the pre-stored data of the identity management system.

More optionally, the pairing algorithm comprises at least one of a weighted cosine and a machine learning feature tree.

Optionally, the method further comprises transmitting the at least one graph to the plurality of users.

In another aspect, an embodiment of the present disclosure provides a system comprising:

a server having an identity management system, wherein the identity management system has a plurality of users connected thereto when in operation using respective computing devices through a data communication network, the identity management system comprises:
a transceiving module for receiving data associated with the plurality of users;
a database for storing the data associated with the plurality of users versus a pre-stored data associated with the identity management system in a partitioned fashion; and
a processing module for:
   integrating the data associated with the plurality of users and the pre-stored data of the identity management system; and
   comparing the data associated with the plurality of users and the pre-stored data of the database to generate at least one graph indicating at least one pattern between the data associated with the plurality of users and the pre-stored data of the identity management system.

### BRIEF DESCRIPTION OF THE FIGURES

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIGS. 1A-1C are schematic illustrations of various exemplary systems for synchronizing identifiers associated with a plurality of users, in accordance with various embodiments of the present disclosure;

FIG. 2 is a block diagram of a server having an identity management system, in accordance with an embodiment of the present disclosure;

FIG. 3 is a block diagram of a computing device associated with the plurality of users, in accordance with an embodiment of the present disclosure; and

FIG. 4 is an illustration of steps of a method of synchronizing the identifiers associated with the plurality of users, in accordance with an embodiment of the present disclosure.

### DETAILED DESCRIPTION

Descriptions of embodiments of the present disclosure provided below are not intended to limit the scope of claims of the present disclosure. Rather, the inventors have contemplated that the claimed subject matter might also be embodied in other ways, to include different steps or elements similar to the ones described in this document, in conjunction with other present or future technologies. Moreover, although the term “step” may be used herein to denote different aspects of methods employed, the term should not be interpreted as implying any particular order among or between various steps herein disclosed unless and except when the order of individual steps is explicitly described.

Functional units described in this disclosure have been labeled as systems or devices. A module, device, or a system may be implemented in programmable hardware devices such as, processors, digital signal processors, central processing units, field programmable gate arrays, programmable array logic, programmable logic devices, cloud processing systems, or the like. The devices/modules may also be implemented in software for execution by various types of processors. An identified device/module may include executable code and may, for example, comprise one or more physical or logical blocks of computer instructions, which may be, for example, organized as an object, procedure, function, or other construct. Nevertheless, the executable of an identified device/module need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

It will be appreciated that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item. Phrases such as “one or more”, and “at least one”, in a given embodiment relate to the singular, but can also relate to the plural in another given embodiment.

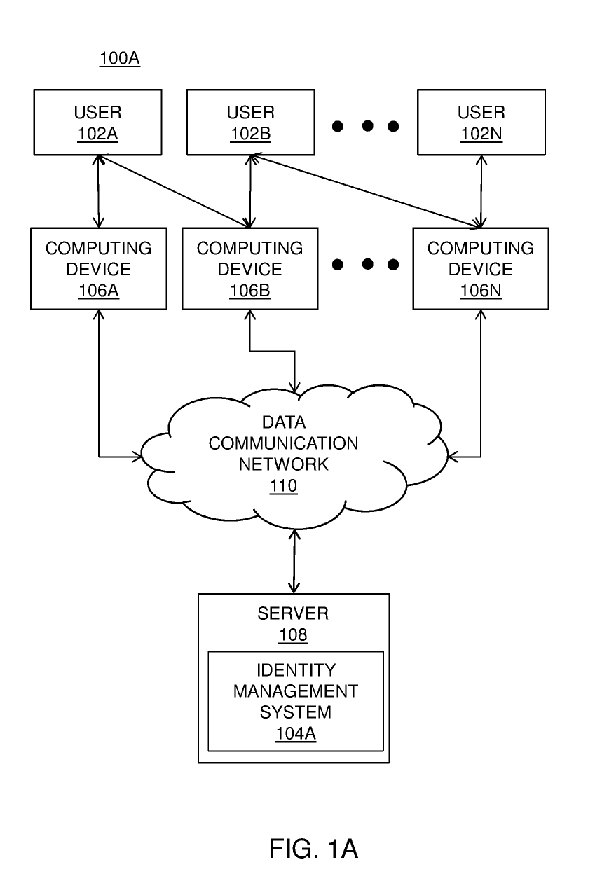

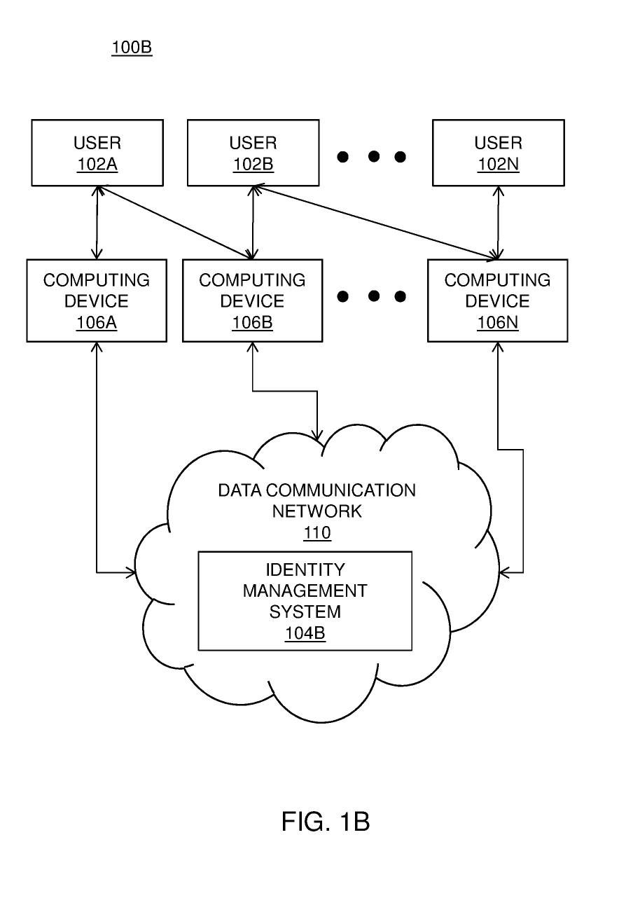

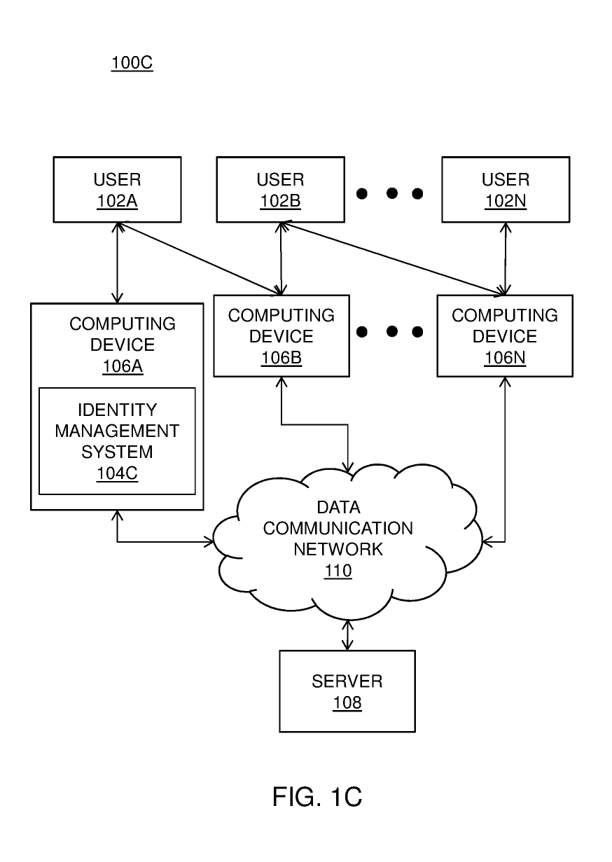

In FIGS. 1A-1C, there are provided schematic illustrations of various exemplary systems 100A-100C for synchronizing identifiers associated with a plurality of users 102A-102N, in accordance with various embodiments of the present disclosure. The synchronization of the identifiers associated with a plurality of users 102A-102N increases, for example maximizes, a scale of a resultant data set of the identity management system 104A-104C. Specifically, the resultant data set is increased, for example maximized, by creating multiple instances of graph in different cookie domains of the plurality of users 102A-102N. The resultant data set is a collection of data associated with the plurality of users 102A-102N and a pre-stored data associated with the identity management system 104A-104C. As shown in FIG. 1A, the system 100A includes a plurality of computing devices (or user devices) 106A-106N associated with the plurality of users 102A-102N. The terms “user device” and “computing device” are used interchangeably on account of mutual similarities in their functionality and structure. In an embodiment, such computing device (or the user device) includes a single device or a combination of multiple devices, which may be capable of communicating, and exchanging one or messages with other devices present in a network.

As shown, the identity management system 104A is present in a server 108. According to an embodiment, the server 108 generally refers to an application, program, process or device that responds to requests for information or services by another application, program, process or device on a communication network, such as a data communication network 110. In the present embodiment, the plurality of computing devices 106A-106N exchanges information with the server 108 (particularly, with the identity management system 104A present therein). According to another embodiment, the server 108 also encompasses software that makes an act of serving information or providing services possible.

The identity management system 104A has the plurality of users 102A-102N coupled thereto using the plurality of computing devices 106A-106N through the data communication network 110. The terms “data communication network” and “network” are used interchangeably on account of mutual similarities in their functionality and structure. Each of the computing devices 106A-106N has an associated device identifier.

In an embodiment, a given user of the plurality of users 102A-102N uses more than one computing device for accessing the data communication network 110 by using same or different user identifiers. For example, the user 102A can use the computing device 106A and the computing device 106B for accessing the data communication network 110. Similarly, the user 102B can use the computing device 106B and the computing device 106N for accessing the data communication network 110. Moreover, each of the users 102A-102N may have more than one associated user identifiers. Examples of the user identifiers may include, but not limited to, a login identifier (ID), a password, a phone number, an image identifier, a name, date of birth of a user, and so forth.

The computing devices 106A-106N may include cell phones, phablet computers, tablet computers, desktop computers, personal digital assistants (PDA), and so forth. A typical example of the computing devices 106A-106N is a wireless data access-enabled device, for example, an iPHONE® smart phone, a BLACKBERRY® smart phone, a NEXUS ONE™ smart phone, an iPAD® device, and so forth, that is capable of sending and receiving data in a wireless manner using protocols like the Internet Protocol (IP), and the wireless application protocol (WAP). A symbol ® here denotes a registered trade mark (trademark).

Furthermore, the data communication network 110 comprises wired or wireless technologies. Examples of the data communication network 110 include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet®, second generation (2G) telecommunication networks, third generation (3G) telecommunication networks, fourth generation (4G) telecommunication networks, and Worldwide Interoperability for Microwave Access (WiMAX) networks.

In operation, the identity management system 104A receives data associated with the plurality of users 102A-102N. The data associated with the plurality of users 102A-102N comprises at least one of a plurality of postbacks, a plurality of pixels, a plurality of logs, cookie information, a plurality of signals, information associated with a plurality of sensors and information associated with a plurality of bots. The term “postbacks” refers to a hypertext transfer protocol (HTTP) post mostly available in editable forms. In an embodiment, the identity management system 104A allows the plurality of users 102A-102N to add the plurality of pixels associated with the identity management system 104A onto their websites using the plurality of computing devices 106A-106N. The plurality of logs may refer to log files provided by the plurality of users 102A-102N having the information (or data) associated with them, which may be present in the form of graphs, text or in any other suitable form. The cookie information, for example, comprises the plurality of user identifiers for identifying the plurality of users 102A-102N. The plurality of bots are software applications running automated scripts over the internet and perform tasks associated therewith.

In other embodiment, the identity management system 104A receives other information associated with the plurality of users 102A-102N, such as the plurality of user identifiers, the plurality of device identifiers, a plurality of channel identifiers (for example, when the users 102A-102N are associated with a plurality of marketing channels), a plurality of platform identifiers (for example, when the users 102A-102N are associated with a plurality of marketing platforms) and so forth.

Further, the identity management system 104A stores the data associated with the plurality of users 102A-102N versus the pre-stored data associated with the identity management system 104A in a partitioned fashion. The pre-stored data includes, for example, some additional device identifiers, additional channel identifiers, additional platform identifiers and so forth. Furthermore, the identity management system 104A integrates the data associated with the plurality of users 102A-102N and the pre-stored data. The identity management system 104A keeps a consolidated view of the information (i.e. the data associated with the plurality of users 102A-102N and the pre-stored data) that is fed with. Any time the plurality of users 102A-102N interact with the identity management system 104A by sending any information (such as the data associated with the plurality of users 102A-102N), the identity management system 104A has never seen before, the identity management system 104A integrates the data associated with the plurality of users 102A-102N and the pre-stored data. Future interactions of the plurality of users 102A-102N with the identity management system 104A includes the most updated pre-stored data, being the preceding pre-stored data aggregated with the new data received from the plurality of users 102A-102N.

The identity management system 104A is operable to compare the data associated with the plurality of users 102A-102N and the pre-stored data of the identity management system 104A to generate at least one graph. The at least one graph indicate at least one pattern between the data associated with the plurality of users 102A-102N and the pre-stored data of the identity management system 104A. Specifically, the identity management system 104A executes a pairing algorithm for comparing the data associated with the plurality of users 102A-102N and the pre-stored data of the identity management system 104A. The pairing algorithm includes, but is not limited to a weighted cosine and a machine learning feature tree.

In an embodiment, the identity management system 104A generates the at least one graph to correspond to the pattern found within the data associated with the plurality of users 102A-102N and the pre-stored data of the identity management system 104A. In an example embodiment, the pattern found within the data associated with the plurality of users 102A-102N may include similarity in data associated with the plurality of users 102A-102N and the pre-stored data. The identity management system 104A identifies in the pre-stored data, different types of patterns. The plurality of users 102A-102N can get back the pre-stored data that matched a pattern. In an embodiment, it is also optionally possible for the plurality of users 102A-102N to get back the level of similarity for each matched data within the pre-stored data that made a specific data point relevant for the used pattern.

In other embodiment, the at least one pattern corresponds to a device pattern found within the data associated with the plurality of users 102A-102N and the pre-stored data of the identity management system 104A. In an exemplary embodiment, the device pattern comprises type of computing devices utilized by the plurality of users 102A-102N. The identity management system 104A determines a device footprint within the data associated with the plurality of users 102A-102N using the device pattern. In an embodiment, the device footprint includes number of computing devices used by the plurality of users 102A-102N. In an embodiment, the identity management system 104A provides a plurality of new device identifiers to the plurality of users 102A-102N, i.e. enables the concept of incremental identifiers. The identity management system 104A allows the plurality of users 102A-102N to increase their device footprint. In an embodiment, the concept of incremental identifiers is referred to here as an increase of device footprint. The plurality of users 102A-102N can use the identity management system 104A to extend their respective audience. This is a byproduct of the identity management system 104A, as connections are not only made between identifiers known to the plurality of users 102A-102N, but also between an identifier known to the plurality of users 102A-102N and another identifier not known to the plurality of users 102A-102N.

Furthermore, the identity management system 104A performs a cookie synchronization with the data associated with the plurality of users 102A-102N to generate a set of matched pairs from the cookies.

In an example, the identity management system 104A identifies and then indicates the user 102A about where the user 102A stands as a whole in the marketplace based upon the comparison of his/her data and the pre-stored data.

In an embodiment, the identity management system 104A keeps the data associated with the plurality of users 102A-102N separate from the pre-stored data. In other words, the identity management system 104A does not use the data associated with the plurality of users 102A-102N for enriching the pre-stored data of the identity management system 104A.

The identity management system 104A further transmits the at least one graph to the plurality of users 102A-102N. The at least one graph shows the pattern found within the data associated with the plurality of users 102A-102N and the pre-stored data of the identity management system 104A.

Referring now to FIG. 1B, the identity management system 104B may be present in a cloud, i.e. on the data communication network 110 or on any network device in the data communication network 110. As shown in FIG. 1C, in another embodiment, an identity management system 104C may be present on a computing device itself. For example, the identity management system 104C may be present on the computing device 106A. The functionality of the identity management systems 104B-104C is similar to the identity management device 104A as described in conjunction with FIG. 1A.

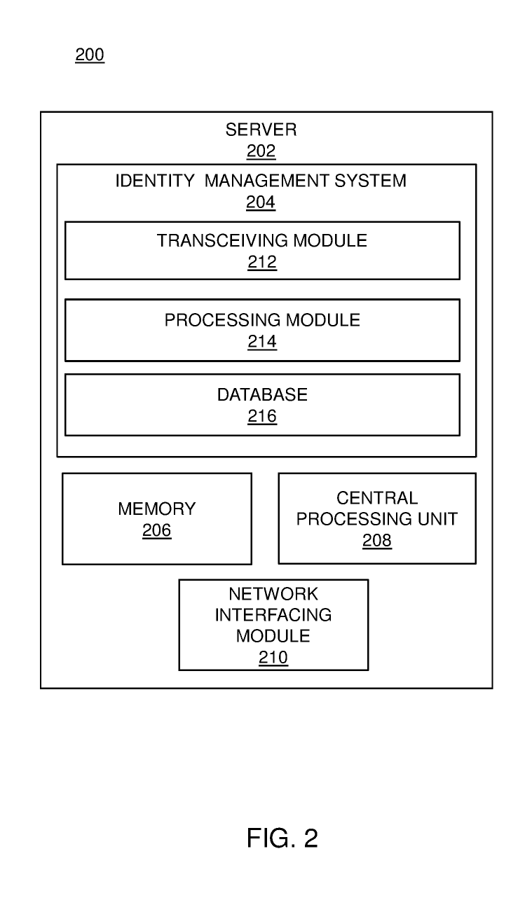

FIG. 2 illustrates a block diagram of a server 202, in accordance with an embodiment of the present disclosure. The server 202 may be a single device or may include more than one device including software, hardware, firmware, or combination of these. As shown, the server 202 primarily includes an identity management system 204, a memory 206, a central processing unit 208 and a network interface module 210. The identity management system 204 may be coupled to a plurality of users (such as the plurality of users 102A-102N of FIG. 1A-1C) using a plurality of computing devices (such as the plurality of computing devices 106A-106N of FIG. 1A-1C) through a data communication network (such as the data communication network 110 of FIG. 1A-1C).

The identity management system 204 includes a transceiving module 212, a processing module 214 and a database 216. The transceiving module 212 is operable to receive the data associated with the plurality of users (such as the plurality of users 102A-102N of FIG. 1A-1C). The data associated with the plurality of users 102A-102N comprises at least one of the plurality of postbacks, the plurality of pixels, the plurality of logs and the cookie information (described above in FIG. 1A). Furthermore, the transceiving module 212 is operable to receive the other information associated with the plurality of users (such as the plurality of users 102A-102N of FIG. 1A-1C). In an embodiment, the other information comprises the plurality of user identifiers, the plurality of device identifiers, a plurality of channel identifiers (for example, when the users 102A-102N are associated with a plurality of marketing channels), a plurality of platform identifiers (for example, when the users 102A-102N are associated with a plurality of marketing platforms) and so forth. The transceiving module 212 is operable to allow a user of the plurality of users 102A-102N or the plurality of users 102A-102N, to opt out of being integrated with the identity management system 204.

The database 216 is operable to store the data associated with the plurality of users 102A-102N versus the pre-stored data associated with the identity management system 204 in a partitioned fashion. Furthermore, the database 216 may be a single or multiple modules or devices including hardware, software, firmware, or combination of these that can be configured to store the pre-stored data associated with the identity management system 204.

The processing module 214 is operable to integrate the data associated with the plurality of users (such as the plurality of users 102A-102N of FIG. 1A-1C) and the pre-stored data of the identity management system 204. Furthermore, the processing module 214 is operable to compare the data associated with the plurality of users 102A-102N and the pre-stored data of the identity management system 204 to generate the at least one graph. The at least one graph indicate the at least one pattern between the data associated with the plurality of users 102A-102N and the pre-stored data of the identity management system 204. Specifically, the identity management system 204 is operable to execute the pairing algorithm for comparing the data associated with the plurality of users 102A-102N and the pre-stored data of the identity management system 204.

The processing module 214 is further operable to determine a device footprint within the data associated with the plurality of users 102A-102N using the device pattern (described in conjunction with FIG. 1A). The transceiving module 212 is further configured to transmit the at least one graph to the plurality of users 102A-102N.

The central processing unit 208 may include a single or, alternatively, multiple modules or devices including a software, hardware, firmware or combination of these, configured to execute instructions stored in a memory 206. The term “memory” refers to a single or multiple modules or devices including hardware, software, firmware, or combination of these, configured to store instructions that can be executed by other modules/devices. The network interfacing module 210 may enable the server 202 to establish connection with the data communication network 110 or/and with other network devices such as the computing devices 106A-106N present in the data communication network 110.

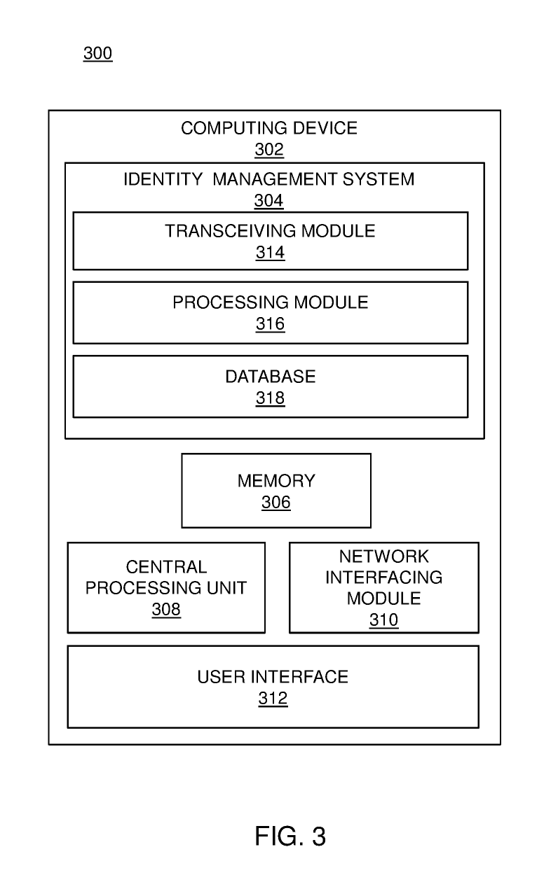

In FIG. 3, there is provided an illustrative a block diagram of a computing device 302 (or a user device), in accordance with an embodiment of the present disclosure. As shown, the computing device 302 includes an identity management system 304, a memory 306, a central processing unit (CPU) 308, a network interfacing module 310 and a user interface 312, as its principal functional elements.

The identity management system 304 includes a transceiving module 314, a processing module 316, and a database 318. In an embodiment, the transceiving module 314, the processing module 316, and the database 318 are similar in functionality with the transceiving module 212, the processing module 214, and the database 216, respectively of the identity management system 204 (explained in conjunction with FIG. 2). Furthermore, the memory 306, the central processing unit 308 and the network interfacing module 310 are similar in structure and function to the memory 206, the central processing unit 208 and the network interfacing module 210, respectively of the server 202 (explained in conjunction with FIG. 2).

In an embodiment, the user interface 312 (or a Graphical User Interface) is meant to be understood broadly as any hardware, or a combination of hardware and software, that enables the plurality of users 102A-102N to interact with a system, program, or device. For example, the user interface 312 can include an interface on a display, such as a screen, of the plurality of computing devices 106A-106N enabling the plurality of users 102A-102N to interact with the plurality of computing devices 106A-106N.

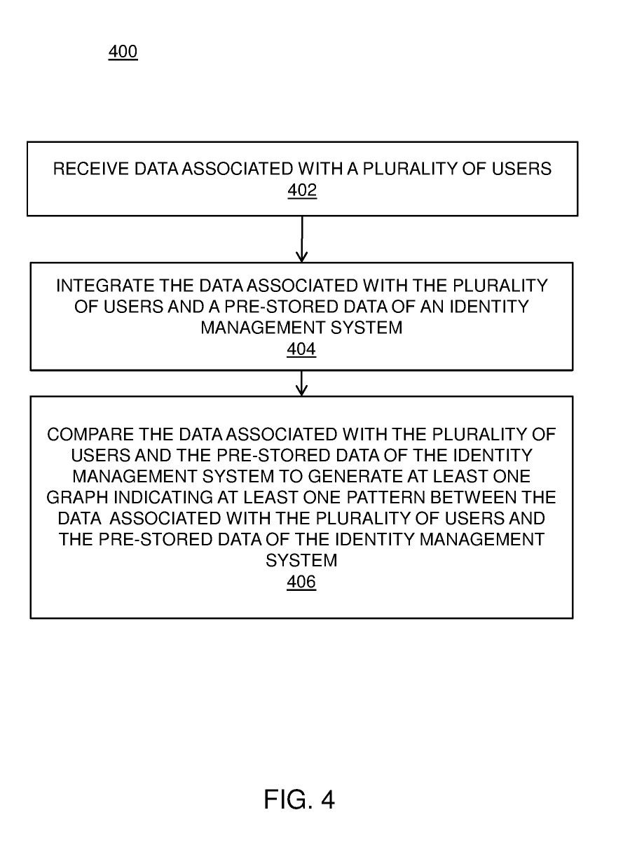

In FIG. 4, there are illustrated steps of a method 400 of synchronizing identifiers associated with a plurality of users (such as the plurality of users 102A-102N), in accordance with an embodiment of the present disclosure.

At a step 402, data associated with the plurality of users is received. The plurality of users has respective computing devices. The computing devices are communicably coupled in operation to an identity management system through a data communication network.

At a step 404, the data associated with the plurality of users and a pre-stored data of the identity management system are integrated.

At a step 406, the data associated with the plurality of users and the pre-stored data of the identity management system are compared to generate at least one graph indicating at least one pattern between the data associated with the plurality of users and the pre-stored data of the identity management system.

Furthermore, the steps 402 to 406 are only illustrative and other alternatives can also be provided where one or more steps are added, one or more steps are removed, or one or more steps are provided in a different sequence without departing from the scope of the claims herein. For example, in the method 400, the at least one pattern is generated to correspond to a device pattern found within the data associated with the plurality of users and the pre-stored data of the identity management system. Moreover, the method 400 further comprises determining a device footprint within the data associated with the plurality of users using a device pattern. Further, the method 400 comprises executing a pairing algorithm when comparing the data associated with the plurality of users and the pre-stored data of the identity management system. Furthermore, the method 400 comprises transmitting the at least one graph to the plurality of users.

The present disclosure provides a method and a system for synchronizing identifiers associated with a plurality of users. The disclosed method and system provide at least one graph to the plurality of users indicating the at least one pattern between the users data and the pre-stored data. The at least one pattern shows how the users data stands as a whole in the marketplace. The disclosed method and system provide some additional device identifiers to the users which enables the users to grow their device footprint. Further, the disclosed method and system keep the users' data separate from the pre-stored data, thereby ensuring the privacy of the users' data.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method comprising:
receiving data associated with a plurality of users, wherein the plurality of users have respective computing devices, and wherein the computing devices are communicably coupled in operation to an identity management system through a data communication network;
integrating the data associated with the plurality of users and a pre-stored data of the identity management system; and
comparing the data associated with the plurality of users and the pre-stored data of the identity management system to generate at least one graph indicating at least one pattern between the data associated with the plurality of users and the pre-stored data of the identity management system.

2. A method of claim 1, including generating the at least one pattern to correspond to a device pattern found within the data associated with the plurality of users and the pre-stored data of the identity management system.

3. A method of claim 2, further comprising determining a device footprint within the data associated with the plurality of users using the device pattern.

4. A method of claim 1, including storing the data associated with the plurality of users versus the pre-stored data associated with the identity management system in a partitioned fashion.

5. A method of claim 1, wherein the data associated with the plurality of users comprises at least one of: a plurality of postbacks, a plurality of pixels, a plurality of logs, cookie information, a plurality of signals, information associated with a plurality of sensors and information associated with a plurality of bots.

6. A method of claim 1, including executing a pairing algorithm when comparing the data associated with the plurality of users and the pre-stored data of the identity management system.

7. A method of claim 6, wherein the pairing algorithm comprises at least one of a weighted cosine and a machine learning feature tree.

8. A method of claim 1, further comprising transmitting the at least one graph to the plurality of users.

9. A system comprising:
a server having an identity management system, wherein the identity management system has a plurality of users connected thereto when in operation using respective computing devices through a data communication network, the identity management system comprises:
a transceiving module for receiving data associated with the plurality of users;
a database for storing the data associated with the plurality of users versus a pre-stored data associated with the identity management system in a partitioned fashion; and
a processing module for:
integrating the data associated with the plurality of users and the pre-stored data of the identity management system; and
comparing the data associated with the plurality of users and the pre-stored data of the database to generate at least one graph indicating at least one pattern between the data associated with the plurality of users and the pre-stored data of the identity management system.

10. A system of claim 9, wherein the at least one pattern corresponds to a device pattern found within the data associated with the plurality of users and the pre-stored data of the identity management system.

11. A system of claim 10, wherein the processing module is further operable to determine a device footprint within the data associated with the plurality of users using the device pattern.

12. A system of claim 9, wherein the data associated with the plurality of users comprises at least one of a plurality of: postbacks, a plurality of pixels, a plurality of logs, cookie information, a plurality of signals, information associated with a plurality of sensors and information associated with a plurality of bots.

13. A system of claim 9, wherein the processing module is further operable to execute a pairing algorithm to compare the data associated with the plurality of users and the pre-stored data of the identity management system.

14. A system of claim 13, wherein the pairing algorithm comprises at least one of a weighted cosine and a machine learning feature tree.

15. A system of claim 9, wherein the transceiving module is further operable to transmit the at least one graph to the plurality of users.
